(19) United States
(12) Patent Application Publication
(10) Pub. No.: US 2016/0050405 A1
(43) Pub. Date: Feb. 18, 2016

(54) APPARATUS AND CAMERA FOR FILMING THREE-DIMENSIONAL VIDEO

(71) Applicant: Seong-Do KIM, (US)

(72) Inventor: Seong-Do KIM, Seoul (KR)

(21) Appl. No.: 14/404,312

(22) PCT Filed: May 28, 2013
(86) PCT No.: PCT/KR2013/004665

§ 371 Date: Nov. 27, 2014

(30) Foreign Application Priority Data
May 29, 2012 (KR) 10-2012-0056826

(51) Int. Cl. H04N 13/02; F16M 11/10; F16M 11/08; F16M 11/04

(52) U.S. Cl. CPC H04N 13/021; F16M 11/048; F16M 11/045; F16M 11/10; F16M 11/08; F16M 11/043

(57) ABSTRACT

Provided is a three-dimensional moving picture photographing apparatus for photographing a three-dimensional moving picture having a large depth, the apparatus including a horizontal track having a forward/rearward moving track and a leftward/rightward moving track, which are perpendicular to each other, a movable body moved along the horizontal track in forward/rearward and leftward/rightward directions, a horizontal rotary bar having one end connected to the movable body via a rotary shaft, and a camera installation section installed at the other end of the horizontal rotary bar, wherein a front portion of the camera installation section is normally directed in a photographing direction of a front surface even when the horizontal rotary bar is rotated.

As a single camera image sensor is used, the three-dimensional moving picture that can be seen without using equipment such as three-dimensional glasses with no optical loss can be photographed. In addition, since the moving picture photographed using the present invention has no problem such as flickering or afterimage and can be seen without using three-dimensional glasses, a person who has only one eye can also see the three-dimensional moving picture. In addition, since the images are photographed while moving in leftward/rightward and forward/rearward directions, the three-dimensional moving picture, which is comfortable, natural and has a large depth, like being seen with the naked eye, can be photographed.

### TECHNICAL FIELD

The present invention relates to a three-dimensional moving picture photographing apparatus and camera that are capable of recognizing a three-dimensional moving picture with the naked eye by continuously photographing moving pictures while moving a camera in forward/rearward and leftward/rightward directions, and more particularly, to a three-dimensional moving picture photographing apparatus and camera that are capable of photographing a three-dimensional moving picture having a large depth by continuously photographing moving pictures while moving the camera in leftward/rightward directions as well as forward/rearward directions.

### BACKGROUND ART

A three-dimensional image technology is in the spotlight as a next-generation image technology for implementing a vivid image. In recent times, various 3D image contents such as movies, education, advertisement, and so on, have been widely manufactured, and a scale of the related market is expected to be widely enlarged due to the distribution of 3D TV.

A technology of photographing a three-dimensional moving picture uses a theory of binocular disparity in which a human sees an object through his/her two eyes. The two eyes are spaced about 65 mm from each other, the left eye and the right eye recognize different two-dimensional images, and finally, the brain superimposes the different two images to provide a three-dimensional feeling. Accordingly, in order to obtain a three-dimensional image, in general, a subject is photographed using two image cameras, which correspond to the left and right eyes, and a left image and a right image are synchronized and superimposed.

When the two image cameras are used as described above, preparing for the photographing is largely time consuming because focuses and main visual angles of the cameras cannot be easily controlled, and making an image is also largely time consuming because a process of combining two images to make a three-dimensional image is very complex. In addition, since optical characteristics of the lens such as spherical aberration, chromatic aberration, and so on, are differently expressed at each lens of the cameras while being minimal, many effects are needed to correct the characteristics.

In order to solve the problems, a technology in which light entering different lenses in different directions are photographed using a half mirror in a crossing manner to obtain the same effect as being photographed by two cameras (Korean Unexamined Patent Application, First Publication No. 2000-24767) has been developed, even in this case, a problem occurs due to a difference in characteristics of the two lenses, and optical loss is increased due to use of the half mirror.

As described above, the three-dimensional moving picture photographing apparatus of the related art using the theory of the binocular disparity commonly has a disadvantage in which a depth in a three-dimensional image is small because images spaced apart leftward and rightward from each other are combined. While a technology in which a subject is disposed at a center and photographed by a plurality of cameras in various directions to increase a depth in a three-dimensional image (Korean Patent Registration No. 10-0324392) has been developed, this is a technology for photographing a stopped three-dimensional image, and a technology for photographing a moving three-dimensional moving picture is still within the technology using the binocular disparity.

While the applicant has filed the invention related to a three-dimensional image photographing apparatus capable of photographing an image while reciprocating a single camera or a lens leftward/rightward and causing the brain to recognize a three-dimensional moving picture without three-dimensional glasses using afterimages of several tens of images per second with no degradation of the image due to the optical loss (Korean Unexamined Patent Application, First Publication No. 2011-0009740), the image photographed while moving leftward/rightward could not provide a large depth in the three-dimensional moving picture.

### SUMMARY OF INVENTION

### Technical Problem

In order to solve the problems, an object of the present invention is to provide a three-dimensional moving picture photographing apparatus and a three-dimensional moving picture photographing camera providing a large depth in a three-dimensional moving picture with no decrease in image quality due to optical loss.

### Solution to Problem

In order to achieve the aforementioned objects, the present invention is directed to provide a three-dimensional moving picture photographing apparatus including: a horizontal track having a forward/rearward moving track and a leftward/rightward moving track, which are perpendicular to each other; a movable body moved along the horizontal track in forward/rearward and leftward/rightward directions; a horizontal rotary bar having one end connected to the movable body via a rotary shaft; and a camera installation section installed at the other end of the horizontal rotary bar, wherein a front portion of the camera installation section is normally directed in a photographing direction of a front surface even when the horizontal rotary bar is rotated.

The present invention is also directed to provide a three-dimensional moving picture photographing camera including: a horizontal track having a forward/rearward moving track and a leftward/rightward moving track, which are perpendicular to each other; a movable body moved along the horizontal track in forward/rearward and leftward/rightward directions; a horizontal rotary bar having one end connected to the movable body via a rotary shaft; a photographing unit connected to the other end of the horizontal rotary bar, normally directed in a photographing direction of a front surface even when the horizontal rotary bar is rotated, and including a lens and an image sensor; and a memory unit configured to receive and store image data photographed by the image sensor of the photographing unit in a wired or wireless manner.

The inventor of the present invention has invented the apparatus and camera capable of variously varying movement in forward/rearward and leftward/rightward directions and photographing images at various positions by adding rotation by the horizontal rotary bar to the horizontal track including the forward/rearward moving track and the leftward/rightward moving track such that the three-dimensional moving picture having a large depth can be photographed while moving the camera or the photographing unit.

The present invention is also directed to provide three-dimensional moving picture photographing apparatus including: a horizontal track having a forward/rearward moving track and a leftward/rightward moving track, which are perpendicular to each other; a movable body moved along the horizontal track in forward/rearward and leftward/rightward directions; a column extending upward from the movable body; a vertical rotary bar having one end connected to an upper section of a front surface of the column via a rotary shaft; and a camera installation section installed at the other end of the vertical rotary bar, wherein an upper section of the camera installation section is normally directed upward even when the vertical rotary bar is rotated.

The present invention is also directed to provide a three-dimensional moving picture photographing camera including: a horizontal track having a forward/rearward moving track and a leftward/rightward moving track, which are perpendicular to each other; a movable body moved along the horizontal track in forward/rearward and leftward/rightward directions; a column extending upward from the movable body; a vertical rotary bar having one end connected to an upper section of the column via a rotary shaft; a photographing unit connected to the other end of the vertical rotary bar, having an upper section normally directed upward even when the vertical rotary bar is rotated, and including a lens and an image sensor; and a memory unit configured to receive and store image data photographed by the image sensor of the photographing unit in a wired or wireless manner.

The inventor of the present invention has invented the apparatus and camera capable of variously varying movement in forward/rearward and leftward/rightward directions and photographing images at various positions by adding rotation by the horizontal rotary bar to the horizontal track including the forward/rearward moving track and the leftward/rightward moving track such that the three-dimensional moving picture having a large depth can be photographed while moving the camera or the photographing unit.

The present invention is also directed to provide a three-dimensional moving picture photographing apparatus including: a horizontal track having a forward/rearward moving track and a leftward/rightward moving track, which are perpendicular to each other; a movable body moved along the horizontal track in forward/rearward and leftward/rightward directions; a vertical track extending upward from the movable body; and a camera installation section installed at the vertical track to be movable upward and downward.

The present invention is also directed to provide a three-dimensional moving picture photographing camera including: a horizontal track having a forward/rearward moving track and a leftward/rightward moving track, which are perpendicular to each other; a movable body moved along the horizontal track in forward/rearward and leftward/rightward directions; a vertical track extending upward from the movable body; a photographing unit installed at the vertical track to be movable upward and downward, and including a lens and an image sensor; and a memory unit configured to receive and store image data photographed by the image sensor of the photographing unit in a wired or wireless manner.

The inventor of the present invention has invented the apparatus and camera capable of variously varying movement in forward/rearward and leftward/rightward directions and photographing images at various positions by adding the vertical track to the horizontal track including the forward/rearward moving track and the leftward/rightward moving track such that the three-dimensional moving picture having a large depth can be photographed while moving the camera or the photographing unit.

The present invention is also directed to provide a three-dimensional moving picture photographing apparatus including: a circular track, which is horizontally disposed; a movable body moved along the track; and a camera installation section connected to the movable body, wherein a front portion of the camera installation section is normally directed in a photographing direction of a front surface even when the movable body is rotated.

The present invention is also directed to provide a three-dimensional moving picture photographing camera including: a circular track, which is horizontally disposed; a movable body moved along the track; a camera installation section connected to the movable body; a photographing unit connected to the movable body, having a front portion normally directed in a photographing direction of a front surface even when the movable body is rotated, and including a lens and an image sensor; and a memory unit configured to receive and store image data photographed by the image sensor of the photographing unit in a wired or wireless manner.

The inventor of the present invention has invented the apparatus and camera capable of variously varying movement in forward/rearward and leftward/rightward directions and photographing images at various positions by applying the circular track to be movable in leftward/rightward and forward/rearward directions such that the three-dimensional moving picture having a large depth can be photographed while moving the camera or the photographing unit.

Here, lengths in forward/rearward directions and leftward/rightward directions of the circular track can be adjusted. When the length of the circular track is adjusted to vary a shape of the track, a position at which the camera or the photographing unit moves can be varied, and various effects can be obtained upon photographing the three-dimensional moving picture.

### Advantageous Effects of Invention

According to the present invention, a three-dimensional moving picture that can be seen without equipment such as three-dimensional glasses and with no optical loss can be photographed using a single camera or a single image sensor.

In addition, since the moving picture photographed using the present invention has no problem caused by flickering and the afterimage and can be seen without using the three-dimensional glasses, a person who has only one eye can also see the three-dimensional moving picture.

Further, since the image is photographed whole moving the camera leftward/rightward and forward/rearward, the three-dimensional moving picture comfortable and natural similar to being seen with the naked eye and having a large depth can be photographed.

### BRIEF DESCRIPTION OF DRAWINGS

FIG. 1 is a schematic view showing a structure of a three-dimensional moving picture photographing apparatus according to a first embodiment of the present invention;

FIG. 2 is a schematic view showing an operation of the apparatus according to the first embodiment of the present invention;

FIG. 3 is a schematic view showing another operation of the apparatus according to the first embodiment of the present invention;

FIG. 4 is a schematic view showing a structure of a three-dimensional moving picture photographing apparatus according to a second embodiment of the present invention;

FIG. 5 is a schematic view showing a structure of a three-dimensional moving picture photographing apparatus according to a third embodiment of the present invention;

FIG. 6 is a schematic view showing a structure and an operation of a three-dimensional moving picture photographing apparatus according to a fourth embodiment of the present invention; and

FIG. 7 is a schematic view showing shapes to which a circular track of the fourth embodiment of the present invention is modified.

### DESCRIPTION OF EMBODIMENTS

Hereinafter, embodiments of the present invention will be described with reference to the accompanying drawings.

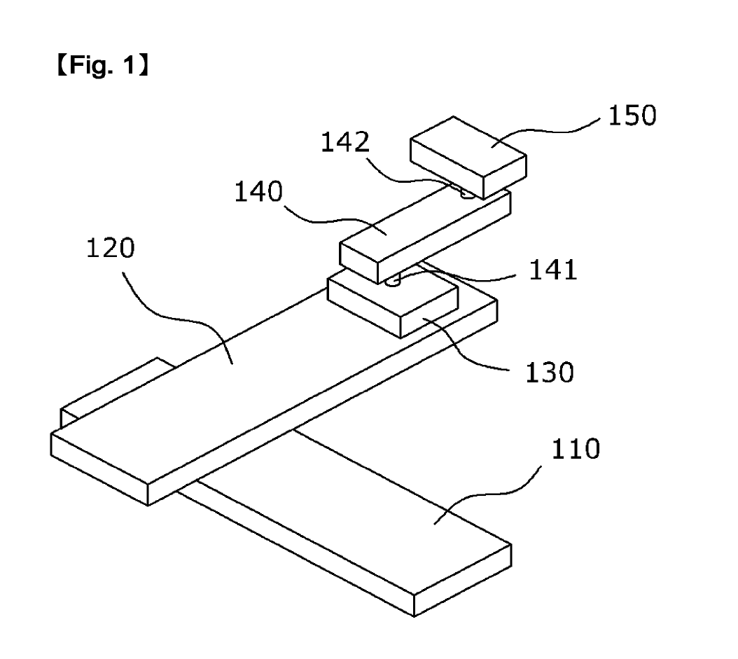

FIG. 1 is a schematic view showing a structure of a three-dimensional moving picture photographing apparatus according to a first embodiment of the present invention.

The three-dimensional moving picture photographing apparatus of the embodiment includes a horizontal track constituted by a forward/rearward moving track 110 and a leftward/rightward moving track 120, a movable body 130, a horizontal rotary bar 140, and a camera installation section 150.

The horizontal track includes the forward/rearward moving track 110 and the leftward/rightward moving track 120, which are linearly formed, disposed to cross each other, and the movable body 130 is moved forward/rearward and leftward/rightward by the forward/rearward moving track 110 and the leftward/rightward moving track 120.

In the embodiment, the leftward/rightward moving track 120 is configured to move forward and rearward along the forward/rearward moving track 110, and the movable body 130 is configured to move along the leftward/rightward moving track 120. Forward/rearward movement of the leftward/rightward moving track 120 and leftward/rightward movement of the movable body 130 are combined such that the movable body 130 is moved forward/rearward and leftward/rightward as a whole.

However, the present invention is not limited to the structure of the embodiment, but a configuration falls into the scope of the present invention as long as a movable body can move forward/rearward and leftward/rightward by two tracks perpendicular to each other.

One end of the horizontal rotary bar 140 is connected to the movable body 130 via a rotary shaft 141 to be rotated on a plane, and the camera installation section 150 is connected to an opposite end thereof. Accordingly, when the horizontal rotary bar 140 is rotated about the rotary shaft 141, the camera installed at an opposite side of the camera installation section 150 is moved in a circular shape. The camera installation section 150 is a section at which the camera configured to photograph a moving picture can be installed, and moves in a circular shape by rotation of the horizontal rotary bar 140. In particular, the camera installation section 150 of the embodiment is connected to the horizontal rotary bar 140 via a rotary shaft 142, and rotated in an opposite direction of the horizontal rotary bar 140 about the rotary shaft 142 according to rotation of the horizontal rotary bar 140, and the camera installation section 150 is always directed to a front side thereof.

In addition, rotation of the camera installation section 150 is adjusted such that a lens of the camera installed at the camera installation section 150 is continuously directed to one point of a preset front side. Specifically, the forward/rearward moving track 110 is adjusted to be directed rightward with reference to when the installation section 150 is disposed at a left side of the forward/rearward moving track 110, and the forward/rearward moving track 110 is adjusted to be directed leftward with reference to when the camera installation section 150 is disposed at a right side of the forward/rearward moving track 110, such that the lens of the camera is directed to one point of the front side.

The structure in which the camera installation section 150 is operated to be directed to one point of the front side and the structure in which the camera is installed at the camera installation section 150 are not particularly limited, and all structures to which one of ordinary skill in the art can apply are possible.

In addition, the camera installed at the three-dimensional moving picture photographing apparatus of the embodiment is not particularly limited as long as the camera can photograph moving pictures recognized as a moving picture due to an afterimage in the brain by photographing several to several hundreds of frames per second.

Hereinafter, an operation of the three-dimensional moving picture photographing apparatus according to the embodiment will be described.

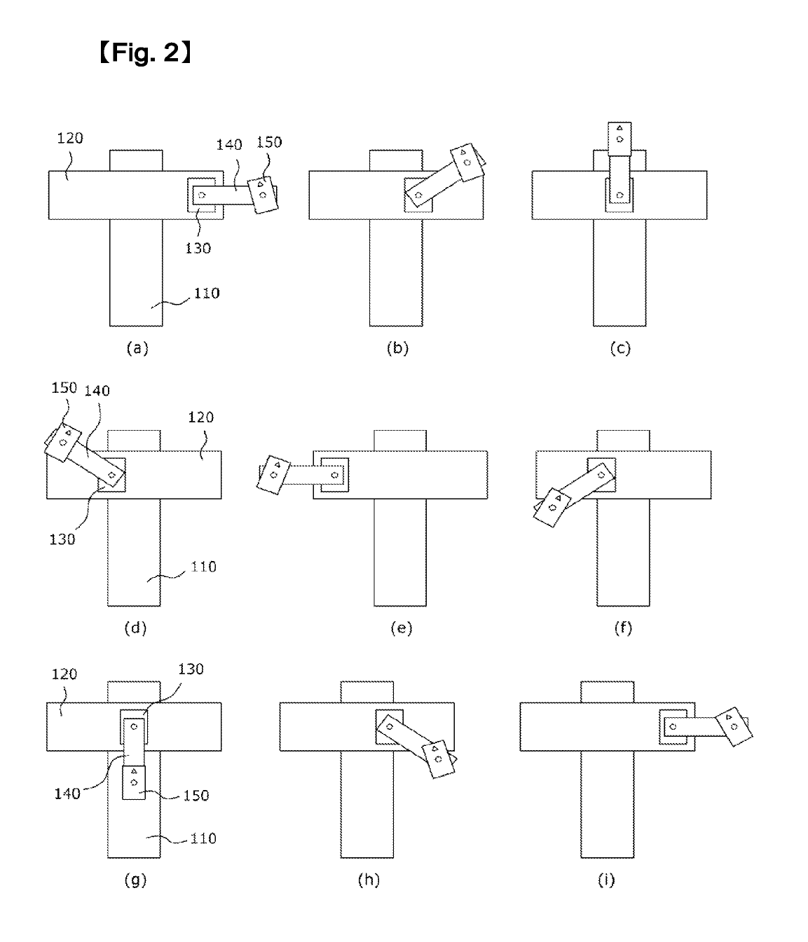

FIG. 2 is a schematic view showing an operation of the apparatus according to the first embodiment of the present invention.

In the operation shown in FIG. 2, since the horizontal rotary bar 140 is rotated in a clockwise direction by one rotation while the movable body 130 reciprocates along the leftward/rightward moving track 120 one time, and the camera installation section 150 moves in an oval shape as a whole, even when there is no movement along the forward/rearward moving track 110, the images can be photographed at various positions in the leftward/rightward and forward/rearward directions to photograph the three-dimensional moving picture having a large depth.

Here, since a front portion marked by A of the camera installation section 150 is continuously directed to one point even when the horizontal rotary bar 140 is rotated, the camera installed at the camera installation section 150 can photograph a scene of the front side at various positions in the leftward/rightward and forward/rearward directions about a specified one point to photograph the three-dimensional moving picture having a large depth.

A plurality of images can be photographed at various positions by leftward/rightward reciprocal movement of the movable body 130 and rotation of the horizontal rotary bar 140, and the images are recognized in the brain as the three-dimensional moving picture having the large depth in the forward/rearward and leftward/rightward directions when the images are sequentially seen.

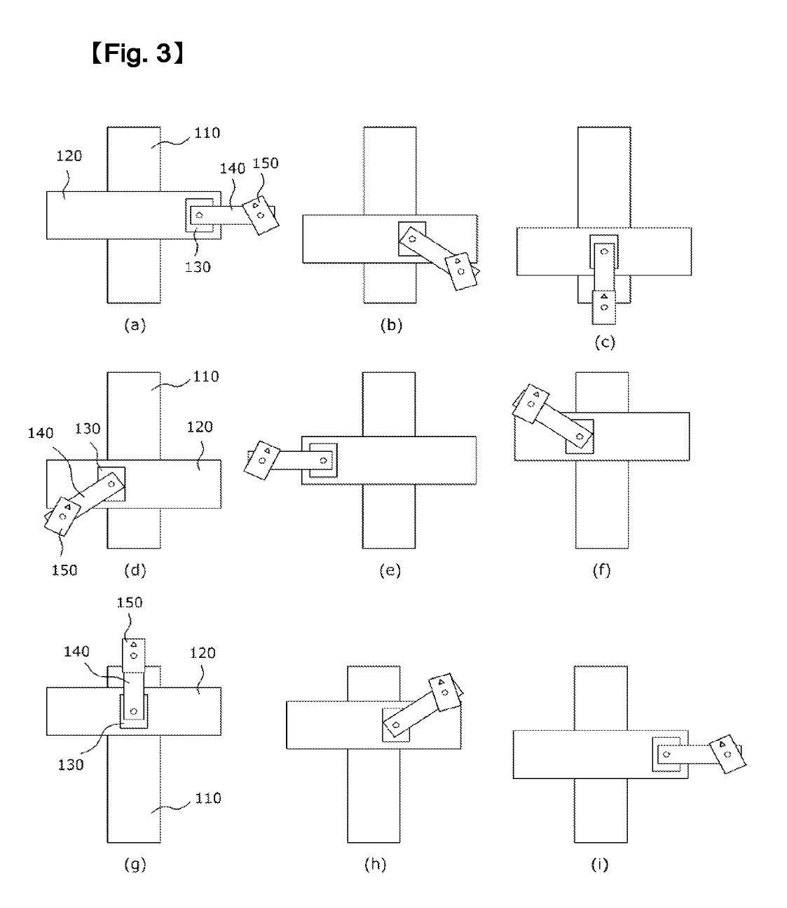

FIG. 3 is a schematic view showing another operation of the apparatus according to the first embodiment of the present invention.

In an operation shown in FIG. 3, while the horizontal rotary bar 140 is rotated in a clockwise direction by one rotation while the movable body 130 reciprocates along the leftward/rightward moving track 120 one time, the leftward/rightward moving track 120 reciprocates rearward and forward along the forward/rearward moving track 110 one time, and thus, the three-dimensional moving picture having a larger depth than the case of FIG. 2 can be photographed while the camera installation section 150 moves like a very large circle as a whole.

Specifically, the movable body 130 is disposed at the most right side of a starting position shown in FIG. 3(a), the horizontal rotary bar 140 is also directed rightward, and the leftward/rightward moving track 120 is disposed at a center of the forward/rearward moving track 110.

Immediately after the photographing starts, in FIG. 3(b), when the movable body 130 is moved leftward along the leftward/rightward moving track 120 and the horizontal rotary bar 140 is moved rearward while rotating in the clockwise direction, the leftward/rightward moving track 120 is moved toward a rear side of the forward/rearward moving track 110.

Next, the horizontal rotary bar 140 is also continuously rotated in the clockwise direction to be directed leftward while the movable body 130 is moved to the most left side of the leftward/rightward moving track 120 as shown in FIG. 3(e), and the leftward/rightward moving track 120 moved forward again from the most rear side of the forward/rearward moving track 110 (see FIG. 3(c)) to be disposed at the center of the forward/rearward moving track 110.

In FIGS. 3(f) to 3(i), the movable body 130 is moved from the left side to the right side, the horizontal rotary bar 140 is rotated forward in the clockwise direction by a half rotation, and the leftward/rightward moving track 120 reciprocates along the forward/rearward moving track 110 in a forward direction.

Here, since the front portion marked by A of the camera installation section 150 is continuously directed to one point of the front side even when the horizontal rotary bar 140 is rotated, the camera installed at the camera installation section 150 can photograph a scene of the front side at various positions in the leftward/rightward and forward/rearward directions about the specified one point to photograph the three-dimensional moving picture having a large depth.

As described above, the plurality of images photographed by the camera during the process of leftward/rightward reciprocal movement of the movable body 130, rotation of the horizontal rotary bar 140 and forward/rearward reciprocal movement of the leftward/rightward moving track 120 are recognized in the brain as the three-dimensional moving picture having the large depth in the forward/rearward and leftward/rightward directions.

As shown in FIGS. 2 and 3, an operation range in which the three-dimensional moving picture photographing apparatus of the embodiment is moved is not particularly limited to the range in which the apparatus reciprocates between both ends of the forward/rearward moving track 110 and the leftward/rightward moving track 120, and the operation range can be variously adjusted within the track according to a photographing purpose. Such a moving range may be adjusted by inputting a leftward/rightward reciprocating distance and a forward/rearward reciprocating distance according to necessity, or may be adjusted by a method of previously inputting a leftward/rightward reciprocating distance and a forward/rearward reciprocating distance, which are optimized for a specified case, and shifting a mode according to each circumstance.

In addition, the operation of the three-dimensional moving picture photographing apparatus of the embodiment is not limited to that shown in FIGS. 2 and 3, but the forward/rearward movement, leftward/rightward movement, and rotation may be variously combined to obtain various effects.

Sizes of the forward/rearward moving track 110, the leftward/rightward moving track 120 and the horizontal rotary bar 140 of the embodiment are generally designed with reference to a distance between both eyes. However, since the operation range can be adjusted as described above, the sizes may be designed to be further increased to increase the depth in the three-dimensional moving picture.

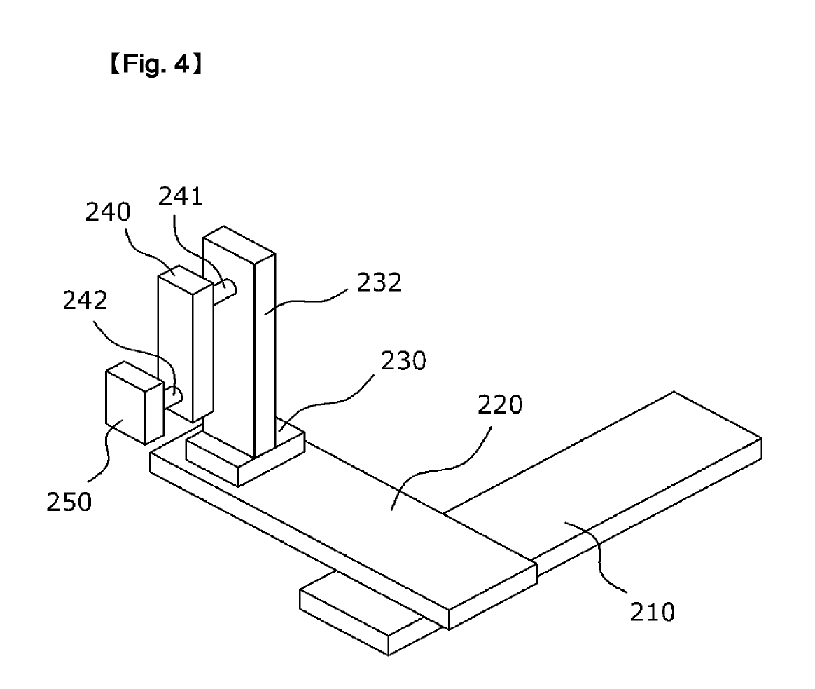

FIG. 4 is a schematic view showing a structure of a three-dimensional moving picture photographing apparatus according to a second embodiment of the present invention.

The three-dimensional moving picture photographing apparatus of the embodiment includes a horizontal track constituted by a forward/rearward moving track 210 and a leftward/rightward moving track 220, a movable body 230, a vertical rotary bar 240 and a camera installation section 250.

The horizontal track includes the forward/rearward moving track 210 and the leftward/rightward moving track 220, which are linearly formed, perpendicular to each other, and the movable body 230 moves forward/rearward and leftward/rightward by the forward/rearward moving track 210 and the leftward/rightward moving track 220. Since the horizontal track is the same as that of the first embodiment, detailed description thereof will be omitted.

In the embodiment, a column 232 extending upward from the movable body 230 is installed to not collide with the forward/rearward moving track 210 when the vertical rotary bar 240 is rotated, and one end of the vertical rotary bar 240 is connected to a front surface of an upper section of the column 232 via a rotary shaft 241.

The camera installation section 250 is connected to an opposite end of the vertical rotary bar 240, and the camera installed at the camera installation section 250 of the opposite side is moved in a circular shape in a direction perpendicular to the ground when the vertical rotary bar 240 is rotated about the rotary shaft 241.

The camera installation section 250 is a section at which the camera configured to photograph moving pictures can be installed, and is moved in a circular shape in a direction perpendicular to the ground by rotation of the vertical rotary bar 240. In particular, the camera installation section 250 of the embodiment is connected to the vertical rotary bar 240 via a rotary shaft 242 and rotated in an opposite direction of the vertical rotary bar 240 about the rotary shaft 242 according to rotation of the vertical rotary bar 240, and thus, an upper side of the camera installation section 250 is directed upward.

In addition, the lens of the camera installed at the camera installation section 250 is continuously directed to one point of a preset front side by adjusting an angle in a horizontal direction of the camera installation section 250 while the camera installation section 250 is rotated. Specifically, the lens of the camera can be directed to one point of the front side by adjusting the angle to be directed downward with reference to the rotary shaft 241 when the camera installation section 250 is disposed over the rotary shaft 241 using a three-axial apparatus or the like, adjusting the angle to be directed upward with reference to the rotary shaft 241 when the camera installation section 250 is disposed under the rotary shaft 241, adjusting the angle to be directed rightward with reference to the rotary shaft 241 when the installation section 250 is disposed at a left side of the rotary shaft 241, and adjusting the angle to be directed leftward with reference to the rotary shaft 241 when the camera installation section 250 is disposed at a right side of the rotary shaft 241.

The structure in which the upper side of the camera installation section 250 is directed to one point of the front side while being directed upward and the structure in which the camera is installed at the camera installation section 250 are not particularly limited, and all structures to which one of ordinary skill in the art can apply are possible. In addition, the camera installed at the three-dimensional moving picture photographing apparatus of the embodiment is not particularly limited as long as the camera can photograph moving pictures recognized as a moving picture due to an afterimage in the brain by photographing several to several hundreds of frames per second.

In an operation of the apparatus according to the second embodiment, while the movable body 230 reciprocates in leftward/rightward directions or in leftward/rightward and forward/rearward directions by the forward/rearward moving track 210 and the leftward/rightward moving track 220, the vertical rotary bar 240 is rotated and the camera installed at the camera installation section 250 is moved in a circular shape in a direction perpendicular to the ground. According to the above-mentioned operation, the camera can sequentially photograph the images at various positions in forward/rearward, leftward/rightward and upward/downward directions, and the images photographed as described above are recognized in the brain as the three-dimensional moving picture having a large depth in the upward/downward direction as well as in the forward/rearward and leftward/rightward directions.

Since the operation range and shape in which the three-dimensional moving picture photographing apparatus of the embodiment is not particularly limited but variously adjusted are similar to that of the first embodiment, detailed description thereof will be omitted.

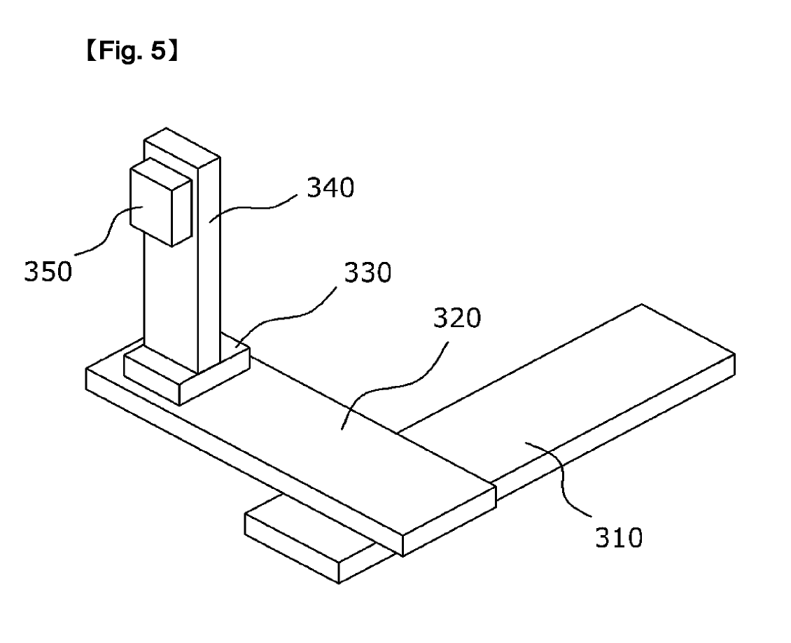

FIG. 5 is a schematic view showing a structure of a three-dimensional moving picture photographing apparatus according to a third embodiment of the present invention.

The three-dimensional moving picture photographing apparatus of the embodiment includes a horizontal track constituted by a forward/rearward moving track 310 and a leftward/rightward moving track 320, a movable body 330, a vertical track 340 and a camera installation section 350.

The horizontal track includes the forward/rearward moving track 310 and the leftward/rightward moving track 320, which are linearly formed, disposed perpendicular to each other, and the movable body 330 is moved in forward/rearward and leftward/rightward directions by the forward/rearward moving track 310 and the leftward/rightward moving track 320. Since the horizontal track is similar to that of the first and second embodiments, detailed description thereof will be omitted.

In the embodiment, in order to increase the depth in the upward/downward directions, the vertical track 340 is vertically installed above the movable body 330, and the camera installation section 350 is movable along the vertical track 340 in the upward/downward directions.

The camera installed at the three-dimensional moving picture photographing apparatus of the embodiment is not particularly limited as long as the camera can photograph moving pictures recognized as a moving picture due to an afterimage in the brain by photographing several to several hundreds of frames per second. In addition, the structure in which the camera is installed at the camera installation section 350 is not particularly limited, and all structures to which one of ordinary skill in the art can apply are possible.

In the operation of the apparatus according to the third embodiment, while the movable body 330 reciprocates in leftward/rightward directions or in leftward/rightward and forward/rearward directions by the forward/rearward moving track 310 and the leftward/rightward moving track 320, the camera installation section 350 is moved along the vertical track 340 in upward/downward directions. Here, while the camera installation section 350 is moved in the upward/downward directions, the lens of the camera installed at the camera installation section 350 is continuously directed to one point of a preset front side by adjusting an angle in a horizontal direction of the camera installation section 350. Specifically, the lens of the camera can be directed to one point of the front side by adjusting the angle to be directed downward with reference to a center of the vertical track 340 when the camera installation section 350 is disposed over the center of the vertical track 340 using a three-axial apparatus or the like, and adjusting the angle to be directed upward with reference to the center of the vertical track 340 when the camera installation section 350 is disposed under the center of the vertical track 340.

According to the operation, the camera can sequentially photograph the images at various positions in the forward/rearward, leftward/rightward and upward/downward directions, and the images photographed as described above are recognized in the brain as the three-dimensional moving picture having a large depth in the upward/downward directions as well as in the forward/rearward and leftward/rightward directions.

Since the operation range and shape in which the three-dimensional moving picture photographing apparatus of the embodiment is not particularly limited but variously adjusted are similar to that of the first and second embodiments, detailed description thereof will be omitted.

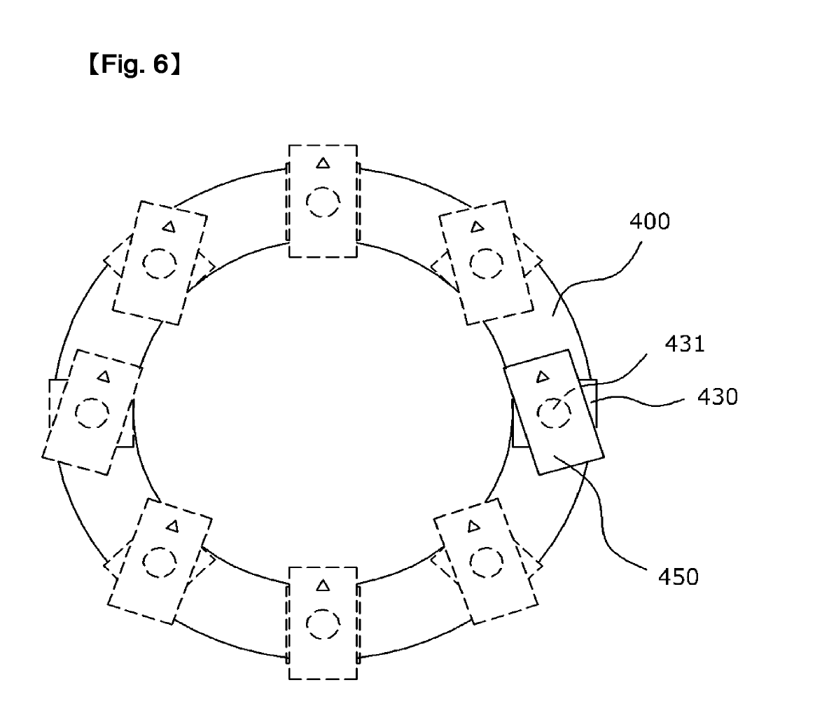

FIG. 6 is a schematic view showing a structure and an operation of a three-dimensional moving picture photographing apparatus according to a fourth embodiment of the present invention.

The three-dimensional moving picture photographing apparatus of the embodiment includes a circular track 400, a movable body 430 and a camera installation section 450.

The movable body 430 of the embodiment is moved along the circular track 400 in a circular shape, and the camera installation section 450 is connected to the movable body 430.

The camera installation section 450 is a section at which the camera configured to photograph moving pictures can be installed, and is moved with the movable body 430 in a circular shape. In particular, the camera installation section 450 of the embodiment is connected to the movable body 430 via a rotary shaft 431 and rotated in an opposite direction of the circular movement direction of the movable body 430 about the rotary shaft 431 according to circular movement of the movable body 430, and thus, the camera installation section 450 is directed toward the front side.

In addition, the lens of the camera installed at the camera installation section 450 is continuously directed to one point of a preset front side by adjusting rotation of the camera installation section 450. Specifically, the lens of the camera can be directed to the one point of the front side by adjusting the angle to be directed rightward with reference to a center of the circular track 400 when the installation section 450 is disposed at a left side of the center of the circular track 400, and adjusting the angle to be directed leftward with reference to the center of the circular track 400 when the camera installation section 450 is disposed at a right side of the center of the circular track 400.

As shown by a dotted line of FIG. 6, since the camera installation section 450 is also rotated about the rotary shaft 431 such that the front side marked by A of the camera installation section 450 is continuously directed to one point of the front side while the movable body 430 is moved along the circular track 400 in a circular shape, the camera installed at the camera installation section 450 can photograph a scene of the front side at various positions in the leftward/rightward and forward/rearward directions with reference to one point to photograph the three-dimensional moving picture having a large depth.

The structure in which the camera installation section 450 is operated to be directed to one point of the front side and the structure in which the camera is installed at the camera installation section 450 are not particularly limited, and all structures to which one of ordinary skill in the art can apply are possible.

In addition, the camera installed at the three-dimensional moving picture photographing apparatus of the embodiment is not particularly limited as long as the camera can photograph moving pictures recognized as a moving picture due to an afterimage in the brain by photographing several to several hundreds of frames per second.

Meanwhile, the circular track 400 of the embodiment is formed of a resilient material, and may be modified into various oval shapes.

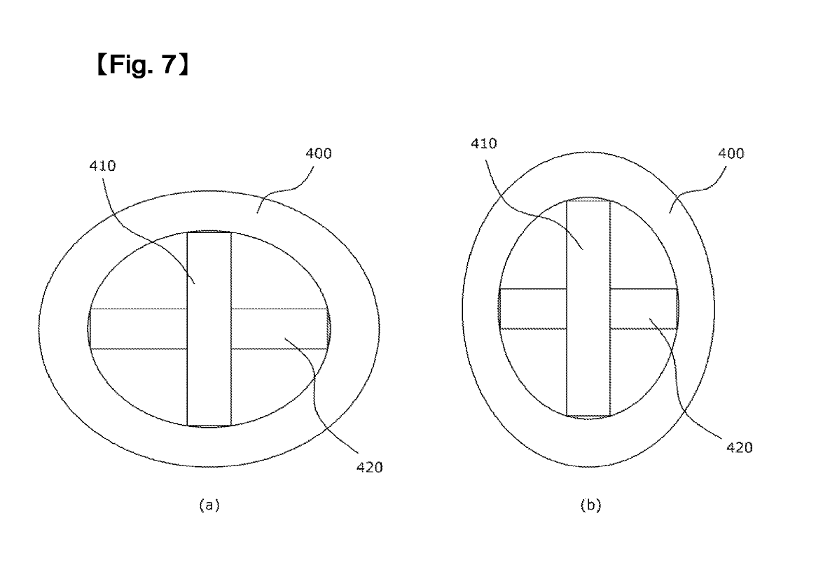

FIG. 7 is a schematic view showing shapes to which a circular track of the fourth embodiment of the present invention is modified.

In FIG. 7, as examples of varying the shape of the circular track 400, a shape in which the circular track 400 is varied into an oval shape elongated in the forward/rearward directions and an oval shape elongated in the leftward/rightward directions by adjusting lengths of a forward/rearward adjustment shaft 410 and a leftward/rightward adjustment shaft 420 is shown. The method of adjusting the lengths of the forward/rearward adjustment shaft 410 and the leftward/rightward adjustment shaft 420 may be variously configured using a linear motor or rotating a threaded shaft.

In addition, the method of modifying the shape of the circular track is not particularly limited, but all structures to which one of ordinary skill in the art can apply are possible.

The exemplary embodiments of the three-dimensional moving picture photographing apparatus according to the present invention have been described. The three-dimensional moving picture photographing apparatus is configured to be used by attaching a separately produced moving picture photographing camera.

However, the track according to the embodiment moving in the forward/rearward, leftward/rightward and/or upward/downward directions may be applied to the three-dimensional moving picture photographing camera included in the housing.

In recent times, along with development of the digital camera technology, the lens and the image sensor has been miniaturized. Accordingly, in the first to fourth embodiments, the camera in which the photographing unit including the lens and the image sensor is installed at the position of the camera installation section 150, 250, 350 or 450, and image data photographed by the image sensor is transmitted to a memory unit in a wired or wireless manner to be stored may be provided.

In particular, while a housing, a memory, and so on, are included in the camera to increase a volume thereof when a separately produced camera is used, since the volume is not increased when the photographing unit is constituted by the minimum number of parts including the lens and the image sensor, a camera in which a track, a photographing unit, a memory unit, and so on, are installed in one housing can be manufactured.

The three-dimensional moving picture photographing camera according to the embodiment of the present invention is characterized in that the photographing unit including the lens and the image sensor is previously mounted on the three-dimensional moving picture photographing apparatus and installed in one housing, and components of a general camera can be applied to the components related to the configuration and the operation of the other cameras. Accordingly, detailed description of the configuration and the operation of the camera will be omitted.

As described above, the three-dimensional moving picture photographing apparatus and camera of the present invention can photograph the three-dimensional moving picture having a large depth in the forward/rearward directions as the camera or the photographing unit photographs images at various positions in the leftward/rightward directions as well as the forward/rearward directions.

In particular, in some of the embodiments, as the images are photographed at various positions in the upward/downward directions as well as the leftward/rightward and forward/rearward directions, the three-dimensional moving picture having a large depth in the upward/downward direction can be photographed.

Embodiments of the invention have been discussed above with reference to the accompanying drawings. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

1. A three-dimensional moving picture photographing apparatus comprising:
a horizontal track having a forward/rearward moving track and a leftward/rightward moving track, which are perpendicular to each other;
a movable body moved along the horizontal track in forward/rearward and leftward/rightward directions;
a horizontal rotary bar having one end connected to the movable body via a rotary shaft; and
a camera installation section installed at the other end of the horizontal rotary bar,
wherein a front portion of the camera installation section is normally directed in a photographing direction of a front surface even when the horizontal rotary bar is rotated.

2. A three-dimensional moving picture photographing camera comprising:
a horizontal track having a forward/rearward moving track and a leftward/rightward moving track, which are perpendicular to each other;
a movable body moved along the horizontal track in forward/rearward and leftward/rightward directions;
a horizontal rotary bar having one end connected to the movable body via a rotary shaft;
a photographing unit connected to the other end of the horizontal rotary bar, normally directed in a photographing direction of a front surface even when the horizontal rotary bar is rotated, and including a lens and an image sensor; and
a memory unit configured to receive and store image data photographed by the image sensor of the photographing unit in a wired or wireless manner.

3. A three-dimensional moving picture photographing apparatus comprising:
a horizontal track having a forward/rearward moving track and a leftward/rightward moving track, which are perpendicular to each other;
a movable body moved along the horizontal track in forward/rearward and leftward/rightward directions;
a column extending upward from the movable body;
a vertical rotary bar having one end connected to an upper section of a front surface of the column via a rotary shaft; and
a camera installation section installed at the other end of the vertical rotary bar,
wherein an upper section of the camera installation section is normally directed upward even when the vertical rotary bar is rotated.

4. A three-dimensional moving picture photographing camera comprising:
a horizontal track having a forward/rearward moving track and a leftward/rightward moving track, which are perpendicular to each other;
a movable body moved along the horizontal track in forward/rearward and leftward/rightward directions;
a column extending upward from the movable body;
a vertical rotary bar having one end connected to an upper section of the column via a rotary shaft;
a photographing unit connected to the other end of the vertical rotary bar, having an upper section normally directed upward even when the vertical rotary bar is rotated, and including a lens and an image sensor; and
a memory unit configured to receive and store image data photographed by the image sensor of the photographing unit in a wired or wireless manner.

5. A three-dimensional moving picture photographing apparatus comprising:
a horizontal track having a forward/rearward moving track and a leftward/rightward moving track, which are perpendicular to each other;
a movable body moved along the horizontal track in forward/rearward and leftward/rightward directions;
a vertical track extending upward from the movable body; and
a camera installation section installed at the vertical track to be movable upward and downward.

6. A three-dimensional moving picture photographing camera comprising:
a horizontal track having a forward/rearward moving track and a leftward/rightward moving track, which are perpendicular to each other;
a movable body moved along the horizontal track in forward/rearward and leftward/rightward directions;
a vertical track extending upward from the movable body;
a photographing unit installed at the vertical track to be movable upward and downward, and including a lens and an image sensor; and
a memory unit configured to receive and store image data photographed by the image sensor of the photographing unit in a wired or wireless manner.

7. A three-dimensional moving picture photographing apparatus comprising:
a circular track, which is horizontally disposed;
a movable body moved along the track; and
a camera installation section connected to the movable body,
wherein a front portion of the camera installation section is normally directed in a photographing direction of a front surface even when the movable body is rotated.

8. The three-dimensional moving picture photographing apparatus according to claim 7, wherein lengths in forward/rearward directions and leftward/rightward directions of the circular track are able to be adjusted.

9. A three-dimensional moving picture photographing camera comprising:
a circular track, which is horizontally disposed;
a movable body moved along the track;
a camera installation section connected to the movable body;
a photographing unit connected to the movable body, having a front portion normally directed in a photographing direction of a front surface even when the movable body is rotated, and including a lens and an image sensor; and
a memory unit configured to receive and store image data photographed by the image sensor of the photographing unit in a wired or wireless manner.

10. The three-dimensional moving picture photographing camera according to claim 9, wherein lengths in forward/rearward directions and leftward/rightward directions of the circular track are able to be adjusted.
